(19) United States
(12) Patent Application Publication
(10) Pub. No.: US 2025/0085143 A1
(43) Pub. Date: Mar. 13, 2025

(54) Sensor with Quality Evaluation and a Digital Output

(71) Applicant: Robert Bosch GmbH, Stuttgart (DE)

(72) Inventors: Ahmad Adee, Rutesheim (DE); Roman Gansch, Renningen (DE); Andreas Heyl, Weil Der Stadt (DE)

(21) Appl. No.: 18/727,214

(22) PCT Filed: Dec. 7, 2022
(86) PCT No.: PCT/EP2022/084696

§ 371 Date: Jul. 8, 2024

(30) Foreign Application Priority Data
Jan. 10, 2022 (DE) 10 2022 200 151.6

(51) Int. Cl. G01D 21/00

(52) U.S. Cl. CPC G01D 21/00

(57) ABSTRACT

A sensor has a sensor element, a sensor data output, a data interface, sensor electronics, and an evaluation apparatus. The sensor element is configured to determine a physical measured variable. The sensor electronics are configured to convert the physical measured variable into sensor data that are output via the sensor data output. The evaluation apparatus is configured to determine a grade of the sensor data based on at least one parameter and to output the grade using the data interface.

The invention relates to a sensor, a method for providing a sensor, and a vehicle having such a sensor.

### PRIOR ART

Sensors are known that utilize sensor data in vehicles with driver assistance systems or with devices for automated execution of driving functions to control the driver assistance system or device for automated execution of driving functions. In order to do so, it is necessary to detect potentially hazardous situations. In particular, it may be necessary to recognize to what extent the current sensor data should be trusted or whether the current sensor data may be erroneous.

### DISCLOSURE OF THE INVENTION

An object of the invention is to provide an improved sensor. A further object of the invention is to provide a vehicle with such a sensor.

Said objects are achieved by the subject matters of the independent patent claims. Advantageous further embodiments are given in the dependent claims.

A sensor comprises a sensor element, a sensor data output, a data interface, sensor electronics, and an evaluation apparatus. The sensor element is configured to determine a physical measured variable. It may be provided that the sensor element can convert the physical measured variable into an electronically readable variable such as, for example, a voltage or an electrical current. The sensor electronics are configured to convert the physical measured variable into sensor data output. The evaluation apparatus is configured to determine a grade of the sensor data based on at least one parameter and output it via the data interface. The parameter can be determined from the physical measured variable or the sensor data, for example.

Thus, the evaluation apparatus is used to determined how reliable the current sensor data is. The grade thus includes a measure of the extent to which a driver assistance system or device for automated execution of driving functions may rely on the sensor data.

The sensor elements may in particular comprise cameras, LIDAR devices and RADAR devices. The parameter or parameters may be selected from the following:
Environmental parameters such as weather conditions, light levels, and time of day,
Road conditions, such as a reflectivity of the road surface (for example, due to a film of water) or water wetting with resultant spray, which may impair camera and/or LIDAR measurements,
Street geometry and street topology, for example the type of road (highway, expressway, general rural road and local road) or the course of the road (straight, curving),
Dynamic conditions such as radar or LIDAR interference due to the sensors of other vehicles or high traffic density, as this makes grading the driving situation more complex.

In particular, it may be provided to consider which of these parameters have a major impact on the sensor data. For example, backlight may significantly affect a measurement result of a camera or a LIDAR device, while a RADAR device is normally less affected by backlight. Thus, linking the parameters to the grade of the sensor data improves confidence in the sensor data, because the sensor is configured to evaluate whether certain measurement problems might exist.

A method of providing such a sensor includes the following steps:
Providing the sensor element, the sensor data output, the data interface, the sensor electronics as well as the evaluation apparatus, wherein the sensor element is configured to determine a physical measured variable, wherein the sensor electronics are configured to convert the physical measured variable into sensor data output, wherein the evaluation apparatus is configured to determine a grade of the sensor data based on at least one parameter and output it via the data interface;
Configuring the evaluation apparatus, wherein field data is transmitted to the rating device and the grade is determined, wherein the grade is compared to reference data.

In one embodiment of the sensor, the evaluation apparatus is configured to read in at least one parameter via the data interface. The parameter read via the data interface may be provided, for example, by a central control unit of the vehicle or by a navigation device. This may be done, for example, via the provision of weather data through a cloud. Further, it may be provided that a position of the vehicle, determined by GPS and transmitted by the navigation device, and a time may be used to determine a sun position and thus lighting conditions, thereby allowing an estimation of whether the light conditions will affect a camera or a LIDAR device. Analogously, it can be additionally considered whether a wet road (for example, due to weather) has additional effects on the lighting conditions.

In one embodiment of the sensor, the evaluation apparatus comprises a computing unit having a probabilistic graphical model. The probabilistic graphical model includes nodes and edges, wherein the nodes comprise the parameters and edges between the nodes describe dependencies of the parameters by means of conditional probabilities.

In one embodiment of the sensor, the probabilistic graphical model comprises a Bayesian network. Both the probabilistic graphical models and the Bayesian networks are well-suited for risk analysis and safety analysis.

This may be configured as a dynamic Bayesian network, for example, or as a fuzzy Bayesian network. In alternative embodiments, the sensor comprises a Credal Network, an Evidential Network or an Extended Evidential Network.

In one embodiment of the sensor, the probabilistic graphical model may calculate the conditional probabilities of the edges using field data and reference values with a predetermined structure of the probabilistic graphical model by synchronizing the field data with the reference values. This may also be utilized in the provision of the sensor. The comparison with reference values can be carried out by means of a referencing person, who compares the sensor data with a real situation and decreases a grade if the sensor data deviates from the real situation. Alternatively or additionally, it may be provided that the reference values comprise sensor data of another sensor, wherein the grade is decreased if the sensor data deviates from the reference values.

In one embodiment of the sensor, the grade of the sensor data comprises a probability of accuracy of the output sensor data. For example, the parameters for which the sensor data are correct and with which probabilities can be stored in the evaluation apparatus, and the probability for the accuracy of the output sensor data may be determined based on this information.

In one embodiment of the sensor, the sensor comprises a system for object detection, wherein objects detected from the physical measured variable are output as sensor data. The grade includes a probability of a false positive value for a detected object and a probability of a false negative value for an undetected object. This allows for a sensor whose sensor data and grade can be further processed easily.

In one embodiment of the sensor, the sensor data comprise detected objects, distances, and directions of the detected objects. This may include, for example, partitioning a field of view of the sensor into a grid, and determining information about a potential detected object and a distance of the object for each point of the grid. The directions of the detected objects result from the arrangement of the points of the grid.

In one embodiment of the sensor, the grade comprises at least two spatially different grade values for different measuring directions of the sensor. For example, if the sensor data comprises detected objects, distances, and directions of the detected objects, the grade may include for each detected object and for all directions in which no object has been detected.

In one embodiment of the sensor, multiple parameters are used to determine the grade of the sensor data, wherein the parameter that has most adversely affected the grade of the sensor data is also output. This allows the sensor data and the grade of a sensor to be merged with further sensor data and further grades of further sensors.

A vehicle comprises such a sensor and a device for automated execution of a driving function. The device for automated execution of a driving function comprises a control unit, wherein the sensor outputs the sensor data and the grade to the control unit. The control unit considers the sensor data and the grade during automated execution of the driving function. For example, if an object is detected and output in the sensor data, that object may be considered in trajectory planning. Further, the grade, for example the probability that there is no object at this point, can also be considered. Further, it may be provided that as the grade decreases, the device for automated execution of the driving function performs less risky driving maneuvers, for example by reducing a speed of the vehicle.

Exemplary embodiments of the invention are explained with reference to the following drawings. Shown in the schematic drawing are:

FIG. 1 a sensor;

FIG. 2 a probabilistic graphical model;

FIG. 3 a vehicle having a sensor with a measurement range; and

FIG. 4 a representation of sensor data and a grade of the sensor data.

FIG. 1 shows a sensor 100 comprising a sensor element 110, a sensor data output 120, a data interface 130, sensor electronics 140, and an evaluation apparatus 150. The sensor element 110 is configured to determine a physical measured variable 101. The physical measured variable 101 represents a physical effect on the sensor element 110. The sensor element 110 may be passive, for example, a camera that only receives and further processes external light, or, actively, for example a RADAR or LIDAR sensor element, wherein radio waves or laser beams are output and the reflected radiation is evaluated. The sensor electronics 140 are configured to convert the physical measured variable 101 into sensor data outputs 120. The evaluation apparatus 150 is configured to determine a grade of the sensor data based on at least one parameter and output the parameter via the data interface 130. The parameter can be determined, for example, from the physical measured variable 101 or the sensor data. Thus, the evaluation apparatus 150 is used to determine how reliable the current sensor data are. The grade may include a measure of the extent to which a driver assistance system or device for automated execution of driving functions may rely on the sensor data of the sensor 100.

In contrast to the illustration of FIG. 1, where a sensor data output 120 and data interface 130 are different elements, the sensor data output 120 and data interface 130 may also be integrated into a common interface that assumes both functions.

It may be provided that the evaluation apparatus 150 is configured to read in at least one parameter via the data interface 130. This may in particular comprise parameters determined in further sensors of a vehicle or comprise parameters provided via a cloud or via mobile Internet.

The evaluation apparatus is configured to provide a rating of the reliability of the sensor data based on the parameter. Depending on the type of sensor, different parameters can be considered, because different sensors can react differently to different parameters. For example, the parameters may include environmental parameters such as weather conditions, light levels and time of day, road conditions, such as a reflectivity of the surface of the road (for example, by a film of water) or water wetting with resulting spray, that can interfere with the camera and/or LIDAR measurements, road geometry and topology, for example, the type of road (highway, expressway, general rural road and local road) or the route of the road (straight, curving), and/or dynamic conditions such as radar or LIDAR interference due to the sensors of other vehicles or high traffic density, as this makes grading the driving situation more complex. The stated parameters may affect the measurements of the sensor 100 in different ways. For example, the time of day and the accompanying illumination by the sun, for example, shortly after sunrise or shortly before sunset, can have a greater impact on a camera or a LIDAR sensor than on a RADAR sensor. This distinction is made by the evaluation apparatus 150 and is therefore included in the grade.

Optionally, the sensor electronics 140 comprise a system 141 for object detection. This is configured to detect objects within the sensor data.

FIG. 2 illustrates an exemplary embodiment of an evaluation apparatus 150 that may correspond to the evaluation apparatus 150 of FIG. 1. This comprises a computing unit 160 having a probabilistic graphical model 161. The probabilistic graphical model 161 comprises nodes 170 and edges 177. The nodes 170 comprise the parameters and the edges 177 between the nodes 170 describe dependencies of the parameters by means of conditional probabilities. In the configuration of FIG. 2, this may be, for example, parameters relevant to a camera sensor. This may include, for example, road conditions 171, a spray 172, a weather 173, and lighting 174, as shown in FIG. 2. By way of the edges 177, the road conditions 171 are associated with the spray 172, the spray 172 is associated with the road conditions 171, the weather 173 and lighting 174, the weather 173 is associated with the spray 172 and the lighting 174, and the lighting 174 is associated with the weather 173 and the spray 172.

This means that the road conditions 171 influence the spray 172, for example, because different types of asphalt allow water to drain at different rates and therefore different amounts of spray 172 can be expected. However, the weather 173 and lighting 174 are not affected by the road conditions. The spray 172 or an influence of the spray 172 on the sensor data, on the other hand, depends on all further parameters: the road conditions 171, weather 173 and lighting 174, because, for example, different amounts of water can be expected on the road depending on the weather conditions and the spray 172 has a greater influence on the measurement under certain lighting conditions (such as backlight).

With another edge 177, the spray 172 is associated with a grade 175 that includes a measure for how the sensor data is influenced by the parameters of road conditions 171, spray 172, weather 173, and lighting 174.

In particular, it may be provided to consider which of these parameters 171, 172, 173, 174 have a major influence on the sensor data, for example here the spray 172. Thus, by linking the parameters to the grade of the sensor data, improved confidence is achieved in the sensor data because the sensor 100 is configured to evaluate whether there might be certain measurement problems.

For example, the probabilistic graphical model 161 may comprise a Bayesian network. This may be configured as a dynamic Bayesian network, for example, or as a fuzzy Bayesian network. In alternative embodiments, the probabilistic graphical model 161 is configured as a Credal Network, an Evidential Network, or an Extended Evidential Network.

It may be provided that the probabilistic graphical model 161 may calculate the conditional probabilities of the edges 177 using field data and reference values with a predetermined structure of the probabilistic graphical model 161 by synchronizing the field data with the reference values. This may be done, for example, such that when providing the sensor 100 of FIG. 1, firstly the sensor element 110, the sensor data output 120, the data interface 130, the sensor electronics 140 and the evaluation apparatus 150 are provided and the evaluation apparatus 150 is subsequently configured, wherein the evaluation apparatus 150 transmits field data, which is data measured by the sensor element 110, and the grade is determined wherein the grade is compared to reference data. This comparison may be made, for example, such that a sensor reading is compared to a reference value, wherein the reference value, for example, may comprise sensor data of another sensor or an evaluation of the field data by a human operator. For example, sensor data determined by the camera sensor may be compared by a human to determine whether the sensor electronics 140 are outputting correct sensor data. If this is the case, then the grade is high, if this is not the case, then the grade is low. At the same time, either the field data or the reference may be evaluated by the evaluation apparatus 150 to determine which parameters were present and thus determine the grade as a function of the parameters. For example, if the accuracy of the sensor 100 is reduced in a given weather situation, the weather parameter 173 may be associated with a lower grade for this parameter value.

It may be provided that the grade of the sensor data comprises a probability of accuracy of the output sensor data.

The above-described technique may be particularly employed when the sensor 100 comprises a system for object detection, wherein the system for object detection can particularly be integrated into the sensor electronics 140. In this case, objects detected from the physical measured variable 101 may be output as sensor data, wherein the grade comprises a probability of a false positive for a detected object, wherein the grade comprises a probability of a false negative for an undetected object. In this embodiment, in particular, the comparison of the field data with reference data can be carried out because sensor data relating to detected objects can be easily synchronized by further sensors or by a human operator.

In the above-mentioned embodiments, it is possible for the probabilistic graphical model 161 to define a base structure consisting of node 170 and edges 177 by means of an expert assessment of which parameters interact with which further parameters, and then to calculate the individual conditional probabilities based on the comparison of the reference data with the field data.

It may be provided that multiple parameters 171, 172, 173, 174 may be used to determine the grade of the sensor data, as shown in FIG. 2. In this case, it may be provided that the parameter which has most adversely affected the grade of the sensor data is also output. This allows further information regarding the grade to be transmitted to a device for automated execution of a driving function.

FIG. 3 shows a sensor 100, which may be constructed analogously to the sensor 100 of FIG. 1. An exemplary first measurement direction 181, a second measurement direction 182, a third measurement direction 183, a fourth measurement direction 184, a fifth measurement direction 185, and a sixth measurement direction 186 are shown in a measurement region 180, wherein the number of measurement directions 181, 182, 183, 184, 185, 186 is not limited to six, and more than six measurement directions 181, 182, 183, 184, 185, 186 may be provided. The measurement directions 181, 182, 183, 184, 185, 186 lie in one plane as an example, but they may also lie in more than one plane. It may be provided that the grade includes at least two spatially different grade values for different sensing directions 181, 182, 183, 184, 185, 186 of the sensor 100. In particular, it may be provided that a grade may be associated with each measurement direction 181, 182, 183, 184, 185, 186.

The sensor data may comprise, in particular, detected objects, distances, and directions of the detected objects. It may be provided that for each of the measurement directions 181, 182, 183, 184, 185, 186, it is indicated whether an object was detected, at what distance the object is located, and what the grades for each measurement direction 181, 182, 183, 184, 185, 186 are. For example, for each measurement direction 181, 182, 183, 184, 185, 186 in which an object was detected, the distance of the object and a probability of false positive detection may be provided, and for each measurement direction 181, 182, 183, 184, 185, 186 in which no object was detected, a probability of false negative detection may be provided. The objects and distances are then part of the sensor data; the probabilities are part of the grade.

The sensor 100 of FIG. 3 is, by way of example, integrated within a vehicle 200. This is optional, the sensor 100 may also be operated without the vehicle 200. The sensor 100 of FIG. 1 may be analogously integrated into a vehicle. The sensor data output 120 and the data interface are connected to a device 210 for automated execution of a driving function. The device 210 for automated execution of the driving function includes a control unit 211. The sensor 100 outputs the sensor data to the control unit 211 via the sensor data output 120 and the grade via the data interface 130. The control unit 211 considers the sensor data and the grade during automated execution of the driving function. The driving function may include acceleration or braking, and/or steering, of the vehicle 200.

It may be provided that the sensing directions 181, 182, 183, 184, 185, 186 span a two-dimensional grid. This may include, for example, partitioning a field of view of the sensor 100 into a grid and determining information about a potential detected object and a distance of the object for each point of the grid. The directions of the detected objects result from the arrangement of the points of the grid. Further, a grade may be indicated for each point of the grid so that a total of the grades of the different measurement directions 181, 182, 183, 184, 185, 186 can be output. This may be referred to as a measurement accuracy map, for example.

FIG. 4 shows a representation 190 of sensor data and grades for a sensor having a field of view divided into a grid. A first object 191, a second object 192, and a third object 193 are arranged in the grid. A probability is further indicated for each grid box 194, 195. First grid arrays 194 are grid arrays with detected objects 191, 192, 193, while no objects were detected in the second grid arrays 195. The probabilities indicate the probability of a false positive for the first grid arrays 194 and the probability of a false negative for the second grid arrays. Thus, for the first grid arrays 194, the probabilities indicate how likely it is that there is no real object present in the first grid arrays 194 despite an object being detected 191, 192, 193, and for the second grid arrays 195, the probabilities indicate how likely it is that there is a real object present in the second grid arrays 195, although none has been detected. Additionally, it may be provided that a distance to the object is output for the first grid arrays 194. The sensor data then includes information on the arrangement of the first grid arrays 194 and, if relevant, the distances of the objects 191, 192, 193. The grade includes the probabilities given for the grid arrays 194, 195.

Although the invention has been described in detail by means of the preferred exemplary embodiments, the invention is not limited to the disclosed examples and other variations may be derived therefrom by a person skilled in the art without departing from the scope of protection of the invention.

1. A, comprising:
a sensor element configured to determine a physical measured variable;
a sensor data output;
a data interface;
sensor electronics configured to convert the determined physical measured variable into sensor data that are output by the sensor data output; and
an evaluation apparatus configured to determine a grade of the sensor data based on at least one parameter and to output the determined grade of the sensor using the data interface.

2. The sensor of claim 1, wherein the evaluation apparatus is configured to read at least one parameter using the data interface.

3. The sensor of claim 1, wherein:
the evaluation apparatus comprises a computing unit having a probabilistic graphical model,
the probabilistic graphical model comprises nodes and edges, and
the nodes comprise the at least one parameter and the edges describe dependencies of the at least one parameter between the nodes based on conditional probabilities.

4. The sensor of claim 3, wherein the probabilistic graphical model is configured to calculate the conditional probabilities of the edges based on field data and reference values with predetermined structure of the probabilistic graphical model by synchronizing the field data with the reference values.

5. The sensor of claim 1, wherein the grade of the sensor data comprises a probability of accuracy of the sensor data.

6. The sensor of claim 1, further comprising:
a system for object detection,
wherein objects detected from the determined physical measured variable are output as the sensor data,
wherein the grade of the sensor data comprises a probability of a false positive for a detected object, and
wherein the grade of the sensor data comprises a probability of a false negative for a non-detected object.

7. The sensor of claim 6, wherein the sensor data comprises detected objects, distances, and directions of the detected objects.

8. The sensor of claim 1, wherein the grade of the sensor data comprises at least two spatially different grade values for different sensing directions of the sensor.

9. A method of providing a sensor according to claim 1, comprising:
providing the sensor element, the sensor data output, the data interface, the sensor electronics, and the evaluation apparatus,
determining, using the sensor element, the the physical measured variable,
converting, using the sensor electronics, the physical measured variable into the sensor data and outputting the sensor data using the sensor data output,
determining, using the evaluation apparatus, the grade of the sensor data based on the at least one parameter and outputting the grade of the sensor data using the data interface,
configuring the evaluation apparatus,
transmitting the field data to the evaluation apparatus and determining the grade of the sensor data, and
comparing the grade of the sensor data to reference data.

10. A vehicle comprising:
a sensor according to claim 1; and
a device for automated execution of a driving function, the device for automated execution of the driving function comprising a control unit,
wherein the sensor outputs the sensor data and the grade of the sensor data to the control unit, and
wherein the control unit processes the sensor data and the grade of the sensor data during automated execution of the driving function.
